(19) United States
(12) Patent Application Publication
(10) Pub. No.: US 2020/0141543 A1
(43) Pub. Date: May 7, 2020

(54) HOMOGENEOUS LIGHT WITH MIXING OF WIDEBAND RED LIGHT

(71) Applicant: David Nowak, Powell, TN (US)

(72) Inventor: David Nowak, Powell, TN (US)

(21) Appl. No.: 16/671,769

(22) Filed: Nov. 1, 2019

Related U.S. Application Data
(60) Provisional application No. 62/754,783, filed on Nov. 2, 2018.

(51) Int. Cl. F21K 9/62; F21K 9/66; F21V 3/04; A01G 9/24; A01G 7/04

(52) U.S. Cl. CPC F21K 9/62; F21K 9/66; F21Y 2115/10; A01G 9/249; A01G 7/045; F21V 3/049

(57) ABSTRACT

Devices, systems and/or arrangements for the homogenizing of different colors of light, particularly improved devices, systems and/or arrangements for the homogenizing of wideband red light with non-red light are provided. A light-mixing diffuser cover overlies a red light emitter and a light emitter that emits light at a non-red light wavelength. The diffuser cover serves to mix red light and non-red light emitted from the emitters upon passage of the red light and the non-red light through the diffuser cover.

### CROSS REFERENCE TO RELATED APPLICATION

This application claims the benefit of U.S. Provisional Patent Application, Ser. No. 62/754,783, filed on 2 Nov. 2018. This co-pending Provisional application is hereby incorporated by reference herein in its entirety and is made a part hereof, including but not limited to those portions which specifically appear hereinafter.

### BACKGROUND OF THE INVENTION

### Field of the Invention

This invention relates generally to the processing of light and, more particularly, to the homogenizing of different colors of light.

### Discussion of Related Art

With the advent of LED lighting it has become easy to produce or form different colors of light. The user simply chooses an LED which provides the desired basic color of light. For example, a user desiring red light can simply obtain and utilize a red LED. The user is no longer required to start with white light and filter out the non-red colors. Moreover, the user not only can buy an LED that gives off only red light, the LED would provide a light of very pure red color, a red that had no other colors of light present. This is known as “narrowband” light. For years, LED manufacturers have been perfecting this narrowband process to make LED's of a specific color. In fact, many LED manufacturers have created specific narrowband LED's for use in the horticulture industry.

In horticultural lighting fixtures, it is common in the industry to use LEDs of different colors to produce or form the correct light spectrum the plant requires for photosynthesis. Typically, a cover is provided over the LEDs to protect the LEDs from the greenhouse environment. Such covers have typically been made from a clear material to maximize the transmission of light therethrough. In other embodiments, some manufacturers employ reflectors to focus the light down onto a desired plant. Such arrangements, however, can suffer as different color lights can shine down onto different portions or segments of the desired plant. For example, the upper canopy of leaves can cast shadows onto the lower levels of the canopy such that light is not consistently applied on the upper and lower canopies. Consequently, not all leaves of a plant may see the same color of light. As a result, plants may experience undesired consequences such as undesired reductions in photosynthesis.

Existing light fixture measurement techniques (e.g., IES LM-79-08) are generally designed for lighting fixtures used in human-centric lighting. These measurement techniques are done in what is known as the far-field. Far-field measurements are good for human lighting, as those light fixtures are ultimately used in a far-field environment. With the introduction of LEDs it has become increasingly commonplace for horticulture lighting to now be done in the near-field (due to the reduction in infrared energy emitted from the fixture when compared to incumbent lighting technologies).

Thus, there is a need and a demand devices, systems and arrangements which minimize, reduce or avoid at least some of such shortcomings.

### SUMMARY OF THE INVENTION

A general object of the invention is to provide improved devices, systems and/or arrangements for the homogenizing of different colors of light.

A more specific objective of the invention is to overcome one or more of the problems described above.

The general object of the invention can be attained, at least in part, through a specifically designed or constructed lighting fixture.

In one embodiment, such a lighting fixture includes a wideband red light emitter and a light emitter that emits light at a non-red light wavelength. The lighting fixture further includes a light-mixing diffuser cover overlying the red light emitter and the light emitter that emits light at a non-red light wavelength. The emitters emit their light through the diffuser cover such as to mix the red light and the non-red light emitted from the emitters upon passage of the red light and the non-red light through the diffuser cover.

In accordance with another specific embodiment, a horticulture lighting fixture is provided. Such a horticulture lighting fixture includes a wideband red light emitting LED and a blue light emitting LED. The wideband red light emitting LED desirably includes a source having a spectral half width of greater than 50 nm. The blue light emitting LED desirably emits blue light. The horticulture lighting fixture further includes a light-mixing diffuser cover overlying the red light emitting LED and the blue light emitting LED. The red light and the blue light emitted from the respective LEDs are directed through the light mixing diffuser cover resulting in mixing and homogenizing the red light and the blue light emitted from the respective LEDs.

As used herein, references to “far-field” are to be understood as generally referring to the distance from light to object illuminated >5× diameter of light emitting surface of fixture, whereas references to “near-field” are to be understood as generally referring to a distance from light to object illuminated <5× diameter of light emitting surface of fixture.

As used herein, references to light emitters, including light emitters such as LEDs, that emit light at a “non-red light wavelength” are to be understood as encompassing and including light emitters that emit light in one or more colors besides red. That is, such emitters emit light in one or more colors other than red. It is to be understood that in the broader practice of the invention, suitable such light emitters that emit light at a “non-red light wavelength” may emit light at a red light wavelength in addition to light at a non-red light wavelength. Thus, as will be appreciated by those skilled in the art and guided by the teachings herein provided, in specific embodiments, suitable such light emitters that emit light at a “non-red light wavelength” may include emitters that emit white light, for example.

Other objects and advantages will be apparent to those skilled in the art from the following detailed description taken in conjunction with the appended claims and drawings.

### BRIEF DESCRIPTION OF THE DRAWINGS

FIG. 1 is a simplified schematic showing a horticulture lighting system of the prior art.

FIG. 2 is a simplified schematic showing a horticulture lighting system in accordance with one embodiment of the present invention.

FIG. 3 is a simplified schematic showing a lighting fixture in accordance with one embodiment of the present invention.

Unless otherwise specifically noted, articles depicted in the drawings are not necessarily drawn to scale.

### DETAILED DESCRIPTION OF THE INVENTION

The present invention provides improved or increased homogenization of light involving the mixing of wideband red light.

As detailed below, the invention desirably employs what are referred to as “wideband” red emitters, particularly in the context of lighting for horticulture applications. Wideband emitters have here to before been generally used for horticultural lighting due to the fact that their quantum efficiency is lower than narrowband red emitters. In other words, for a given amount of electrical energy, a more intense red light can generally be obtained using a narrowband rather by using a wideband.

In the present invention, however, a wideband red emitter is preferred as it results or produces different “colors” of red using only one emitter. For example, a single wideband emitter can desirably be employed to provide light that contains 620 nm red, 660 nm deep red and 720 nm far red/near IR, whereas to obtain a light that contains 620 nm red, 660 nm deep red and 720 nm far red/near IR with narrowband emitters would typically require the use 3 different narrowband emitters.

As used herein a “wideband red” is defined as a source whose spectral half width is greater than 50 nm. “Spectral half width” is defined as the range in nanometers at which the optical power is 50% of the power at peak wavelength (λₚ), where peak wavelength (λₚ) occurs at any point between 620-780 nm.

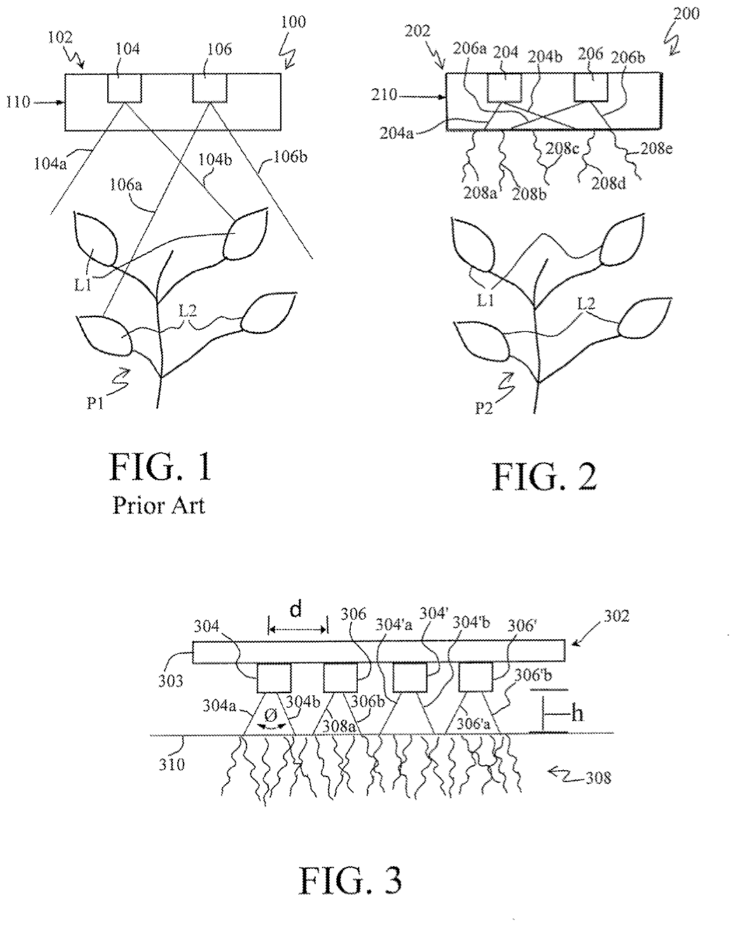

Turning first to FIG. 1, there is shown a simplified schematic of a prior art horticulture lighting system, generally designated by the reference numeral 100. The horticulture lighting system 100 includes a lighting fixture 102 with a narrowband red light LED 104, emitting red color light signified by the light rays 104a and 104b, and a blue light LED 106 diode emitting blue color light signified by the light rays 106a and 106b. The lighting fixture 102 includes or has in combination therewith a cover 110, such as described above, to protect the LEDs 104 and 106 from the ambient environment in which the lighting fixture 102 is disposed, e.g., a greenhouse environment. As identified above, such covers have typically been made from a clear material to maximize the transmission of light therethrough.

Light from such prior art lighting fixtures may be applied unevenly onto associated plant(s). For example, light from the lighting fixture 102 is shown as applied unevenly to the plant P1 as, for example, upper canopy leafs L1 may shade or otherwise obstruct or prevent red color light 104a and 104b, for example, from reaching lower canopy leafs L2 such as may result in undesired reductions in photosynthesis.

With the present invention, such undesired reductions in photosynthesis can be minimized, reduced or can otherwise effectively overcome at least in part through the use of a light-mixing diffuser cover such as herein described.

Turning now to FIG. 2 there is shown a simplified schematic of a horticulture lighting system, generally designated by the reference numeral 200, in accordance with one embodiment of the present invention.

The horticulture lighting system 200 includes a lighting fixture 202 with a wideband red light LED 204, emitting red color light signified by the light rays 204a and 204b, and an LED 206 diode that emits light at a non-red light wavelength, e.g., a blue light LED such as emitting blue color light signified by the light rays 206a and 206b. The lighting fixture 202 includes or has in combination therewith a light-mixing diffuser cover 210. The light-mixing diffuser cover 210, similar to the cover 110 in the lighting system 100 described above, can serve to protect the associated LEDs (here LEDs 204 and 206) from the ambient environment in which the lighting fixture is disposed, e.g., a greenhouse environment. The light-mixing diffuser cover 210, however, also serves or functions to mix or otherwise combine or homogenize light passing therethrough. As shown in FIG. 2, the light-mixing diffuser cover 210 serves or functions to mix or otherwise combine or homogenize the red light rays 204a and 204b with the blue light rays 206a and 206b such as to form mixed, homogenized, or combined light such as respectively signified by the rays 208a, 208b, 208c, 208d and 208e, for example. Such mixed, homogenized, or combined light rays 208a-e as shown can then be applied onto the plant P2 such that the same mixed, homogenized, or combined light is applied in a more uniform manner, e.g., applied to both upper canopy leafs L1 and lower canopy leafs L2 such as may avoid undesired reductions in photosynthesis such as may occur with the prior art, as shown in FIG. 1.

In accordance with certain preferred embodiments, light-mixing diffuser covers used in the practice of the invention can desirably can be made from plastic or glass, preferably highly transparent plastic or glass. Translucent materials can be used, but are generally not preferred as they may not adequately mix, homogenize, or combine the light directed therethrough.

Light-mixing diffuser covers used in the practice of the invention desirably comprise a material effective for light mixing or comprise a light mixing property surface texture molded on or in the cover. Thus, light-mixing diffuser covers in accordance with the invention may include or incorporate the light mixing property or characteristic integral to a material property of a cover, a surface texture molded on a cover, or an additional piece or component that is applied to a cover. For example, surface texturing on glass can be done either with grit blasting or with a chemical etching process, such as may be dependent on the manufacturer of the glass. With plastics, a molding or heat forming of the surface can be preferable from a performance standpoint. Moreover, in some preferred embodiments, the light mixing property surface of the light-mixing diffuser cover is preferably disposed on a light entrance surface of the light-mixing diffuser cover. In some alternative preferred embodiment, the light mixing property surface of the light-mixing diffuser cover is preferably disposed on a light exit surface of the light-mixing diffuser cover. That the invention can be practiced with the light mixing property surface of the light-mixing diffuser cover alternatively disposed on a light entrance surface or a light exit surface of the light-mixing diffuser cover results in or provides increased flexibility such as in manufacturing and environmental sealing methods.

FIG. 3 is a simplified schematic showing a lighting fixture, generally designated by the reference numeral 302, in accordance with one embodiment of the present invention. The lighting fixture 302 includes a circuit board 303 with alternating wideband red light LEDs 304 and 304′, emitting red color light signified by the light rays 304a and 304b and 304′a and 304′b, and LEDs 306 and 306′ that emit light at a non-red light wavelength, i.e., light that contains one or more colors besides red, e.g., blue light LEDs such as emitting blue color light signified by the light rays 306a and 306b and 306′a and 306′b. The lighting fixture 302 includes or has in combination therewith a light-mixing diffuser cover 310. The light-mixing diffuser cover 310, similar to the cover 210 described above, can serve to not only protect the associated LEDs from the ambient environment in which the lighting fixture is disposed, e.g., a greenhouse environment, but also serve or function to mix or otherwise combine or homogenize light passing therethrough. As shown in FIG. 3, the light-mixing diffuser cover 310 serves or functions to mix or otherwise combine or homogenize the red light rays 304a, 304b, 304′a and 304′b with the blue light rays 306a, 306b, 306′a and 306′b such as to form mixed, homogenized, or combined light signified by the rays generally designated by the reference numeral 308, for example.

In the embodiment illustrated in FIG. 3, where:

d=the distance between adjacent covered LEDs;

h=the distance between LEDS and the light-mixing diffuser cover:

Ø=beam angle, the angle to 50% intensity

h is selected to be:

$$\frac{d}{TAN ( φ \text{/} 2 )} \leq h \leq 5 d .$$

While the invention has been described above making specific reference to embodiments that utilize light emitters, e.g., LEDs, that emit blue light as light emitters that emit light at a non-red light wavelength, those skilled in the art and guided by the teachings herein provided will understand and appreciate that in other embodiments suitable such light emitters may include light emitters that emit light in colors in addition to light at non-red light wavelengths such as white light, for example.

As will be appreciated, certain standard elements not necessary for an understanding of the invention may have been omitted or removed from the figures for purposes of facilitating illustration and comprehension.

Thus, the invention provides improved devices, systems and/or arrangements for the homogenizing of different colors of light, particularly improved devices, systems and/or arrangements for the homogenizing of wideband red light with non-red light.

The claims are not intended to include, and should not be interpreted to include, means-plus- or step-plus-function limitations, unless such a limitation is explicitly recited in a given claim using the phrase(s) “means for” or “step for,” respectively.

Although specific advantages have been enumerated above, various embodiments may include some, none, or all of the enumerated advantages.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A lighting fixture, the fixture comprising:
a wideband red light emitter,
a light emitter that emits light at a non-red light wavelength, and
a light-mixing diffuser cover overlying the red light emitter and the light emitter that emits light at a non-red light wavelength and wherethrough the emitters emit their light, the diffuser cover mixing the red light and the non-red light emitted from the emitters upon passage of the red light and the non-red light through the diffuser cover.

2. The lighting fixture of claim 1 wherein the light-mixing diffuser cover comprises a material effective for light mixing.

3. The lighting fixture of claim 1 wherein the light-mixing diffuser cover comprises a light mixing property surface texture molded on or in the cover.

4. The lighting fixture of claim 1 wherein the light mixing property surface of the light-mixing diffuser cover is disposed on a light entrance surface of the light-mixing diffuser cover.

5. The lighting fixture of claim 1 wherein the light mixing property surface of the light-mixing diffuser cover is disposed on a light exit surface of the light-mixing diffuser cover.

6. The lighting fixture of claim 1 wherein the light-mixing diffuser cover comprises a light mixing material added to a light cover.

7. The lighting fixture of claim 1 wherein the wideband red light emitter is an LED.

8. The lighting fixture of claim 7 wherein the wideband red light emitter comprises a source having a spectral half width of greater than 50 nm.

9. The lighting fixture of claim 8 wherein the spectral half width of greater than 50 nm is the distance at which optical power of the appliance is 50% of power at wavelengths between 620-780 nm.

10. The lighting fixture of claim 1 wherein the light emitter that emits light at a non-red light wavelength is an LED.

11. The lighting fixture of claim 1 wherein the light emitter that emits light at a non-red light wavelength emits white light.

12. The lighting fixture of claim 1 wherein the light emitter that emits light at a non-red light wavelength emits blue light.

13. The lighting fixture of claim 1 wherein the wideband red light emitter is a first LED, the non-red light emitter is a second LED, the first LED and the second LED are spaced apart a distance d, and the first and the second LEDs have a beam angle Ø, wherein the light-mixing diffuser cover is spaced a distance h from the first and second LEDs where h is selected to be:
$$\frac{d}{TAN ( φ \text{/} 2 )} \leq h \leq 5 d .$$

14. The lighting fixture of claim 1 wherein the light-mixing diffuser cover comprises a transparent plastic or glass.

15. The lighting fixture of claim 14 wherein the light-mixing diffuser cover comprises a glass surface textured to homogenize light passing therethrough.

16. The lighting fixture of claim 15 wherein a glass surface is chemically etched to form the textured surface.

17. The lighting fixture of claim 14 wherein the light-mixing diffuser cover comprises a plastic surface textured to homogenize light passing therethrough.

18. The lighting fixture of claim 17 wherein the plastic surface is molded to form the textured surface.

19. A horticulture lighting system comprising at least one lighting fixture of claim 1 disposed in a plant lighting arrangement.

20. A horticulture lighting fixture, the fixture comprising:
a wideband red light emitting LED, the wideband red light emitting LED comprising a source having a spectral half width of greater than 50 nm;
a blue light emitting LED that emits blue light, and
a light-mixing diffuser cover overlying the red light emitting LED and the blue light emitting LED and wherethrough the LEDs emit their light, the light mixing diffuser cover mixing and homogenizing the red light and the blue light emitted from the respective LEDs upon passage of the red light and the blue light through the light mixing diffuser cover.
